(19) United States
(12) Patent Application Publication
(10) Pub. No.: US 2025/0007248 A1
(43) Pub. Date: Jan. 2, 2025

(54) SPARK PLUG

(71) Applicant: NITERRA CO., LTD., Nagoya-shi, Aichi (JP)

(72) Inventors: Takakuni OKOCHI, Nagoya-shi, Aichi (JP); Yusuke KAWASHIMA, Nagoya-shi, Aichi (JP)

(73) Assignee: NITERRA CO., LTD., Nagoya-shi, Aichi (JP)

(21) Appl. No.: 18/690,062

(22) PCT Filed: Sep. 7, 2022
(86) PCT No.: PCT/JP2022/033594

§ 371 Date: Sep. 17, 2024

(30) Foreign Application Priority Data
Sep. 16, 2021 (JP) 2021-151130

(51) Int. Cl. H01T 13/36

(52) U.S. Cl. CPC H01T 13/36

(57) ABSTRACT

Provided is a spark plug (10) with which it is possible to reduce cracking of an insulator and leakage of gas. The spark plug comprises an insulator (11) having a distal end facing surface (15) provided on an outer circumference thereof, and a cylindrical main metal fitting (20) disposed at the outer circumference of the insulator, wherein: the main metal fitting is provided with a body portion (21) having a rear end facing surface (22), which is in contact with the distal end facing surface either directly or via another member (31), provided on an inner circumference thereof, and a male thread (23) provided on an outer circumference thereof, a flange portion (24) which includes a seating surface (25) adjacent to a rear end of the body portion, and which protrudes to the outside of the male thread, and a crimped portion (28) which presses the insulator toward the distal end side; and if X (mm) is a distance between the rear end facing surface and the seating surface in an axial direction, and Y (mm) is a thickness obtained by subtracting an inner diameter of the body portion at the position of the seating surface from an effective diameter of the male thread, the following relationships are satisfied: Y≤0.1X+1.48, 17.2≤X≤28.2, and Y≥2.6.

### BACKGROUND OF THE INVENTION

For example, PCT International Patent Application Publication No. WO2011/118087A1 (“Patent Document 1”) discloses a conventional technique in which a spark plug includes a tubular insulator having a frontward facing surface formed on an outer circumference thereof, and a tubular metal shell provided on the outer circumference side of the insulator, and the metal shell includes a rearward facing surface in contact with the frontward facing surface of the insulator directly or via another member, and a crimping portion for pressing the insulator toward the front side.

### FIELD OF THE INVENTION

The present invention relates to a spark plug.

In the conventional technique, as force for pressing the insulator to the front side by the crimping portion is increased, leakage of gas through a gap between the frontward facing surface of the insulator and the rearward facing surface of the metal shell is reduced, but cracking is likely to occur in the root of the frontward facing surface of the insulator. On the other hand, as force for pressing the insulator to the front side by the crimping portion is decreased, cracking is less likely to occur in the root of the frontward facing surface of the insulator, but gas is likely to leak through a gap between the frontward facing surface of the insulator and the rearward facing surface of the metal shell.

### SUMMARY OF THE INVENTION

The present invention has been made to solve the conflicting problems described above, and an object of the present invention is to provide a spark plug capable of reducing occurrence of cracking in an insulator and leakage of gas.

### Means for Solving the Problem

In order to attain the above object, a spark plug includes: an insulator having a tubular shape extending along an axial-line direction and a frontward facing surface formed on an outer circumference thereof; and a tubular metal shell provided on the outer circumference side of the insulator. The metal shell includes: a tubular trunk portion having a rearward facing surface which is formed on an inner circumference thereof and is in contact with the frontward facing surface directly or via another member, and an external thread formed on an outer circumference thereof; a flange portion including a seating surface which is adjacent to a rear end of the trunk portion and protrudes outward with respect to the external thread; and a crimping portion for pressing the insulator toward the front side. When an axial-line-direction distance between the rearward facing surface and the seating surface is represented as X (mm) and a thickness obtained by subtracting an inner diameter of the trunk portion at a position of the seating surface from a pitch diameter of the external thread is represented as Y (mm), Y≤0.1X+1.48, 17.2≤X≤28.2, and Y≥2.6 are satisfied.

### Advantageous Effects of the Invention

According to a first aspect, when the axial-line-direction distance between the rearward facing surface and the seating surface of the metal shell is represented as X (mm) and a thickness obtained by subtracting the inner diameter of the trunk portion at the position of the seating surface from the pitch diameter of the external thread formed on the trunk portion of the metal shell is represented as Y (mm), Y≤0.1X+1.48, 17.2≤X≤28.2, and Y≥2.6 are satisfied. An axial-line-direction force to be applied on the frontward facing surface of the insulator by the metal shell can be made to have an appropriate magnitude, and thus occurrence of cracking in the root of the frontward facing surface of the insulator can be reduced, and furthermore, leakage of gas through a gap between the frontward facing surface of the insulator and the rearward facing surface of the metal shell can be reduced.

According to a second aspect, in the first aspect, Y≥0.1X+0.48 is further satisfied. The axial-line-direction force to be applied on the frontward facing surface of the insulator by the metal shell can be ensured, and thus leakage of gas through a gap between the frontward facing surface of the insulator and the rearward facing surface of the metal shell can be further reduced.

According to a third aspect, in the first or second aspect, an annular packing is interposed between the frontward facing surface of the insulator and the rearward facing surface of the metal shell, and a rear end surface of the packing is in contact with the frontward facing surface of the insulator. In a part of the entire circumference with an axial line as the center, the ratio (%) of a length that the rear end surface of the packing and the frontward facing surface of the insulator are in contact with each other to a length of the rear end surface of the packing on one side of the axial line is different from that on another side of the axial line, in a cross section including the axial line. As compared to the case where the ratios are equal on both sides of the axial line, pressure on the packing can be increased, and thus leakage of gas through a gap between the insulator and the packing can be reduced. A difference in the ratios on both sides of the axial line is not more than 46%, and thus cracking which may occur in the insulator when the insulator is pressed on the inner circumference of the metal shell can be reduced.

According to a fourth aspect, in the third aspect, 23.9≤X≤28.2 is satisfied. The ratios on both sides of the axial line are likely to be different, and thus leakage of gas through a gap between the insulator and the packing can be further reduced.

According to a fifth aspect, in any one of the first to fourth aspects, the external thread has a nominal diameter of 12 mm. Thus, the effect of reducing occurrence of cracking in the insulator and leakage of gas is likely to be increased.

### BRIEF DESCRIPTION OF THE DRAWINGS

FIG. 1 is a half-sectional view of a spark plug according to one embodiment.

FIG. 2 is an enlarged sectional view of a part of the spark plug.

FIG. 3 is an enlarged sectional view of a part of the spark plug.

FIG. 4 (a) illustrates a range in which evaluation in Tests 1-3 was good, FIG. 4 (b) illustrates a range in which evaluation in Tests 1, 2, 4 was good, and FIG. 4 (c) illustrates a range in which a difference in the ratios on both sides of an axial line is likely to occur.

### DETAILED DESCRIPTION OF THE INVENTION

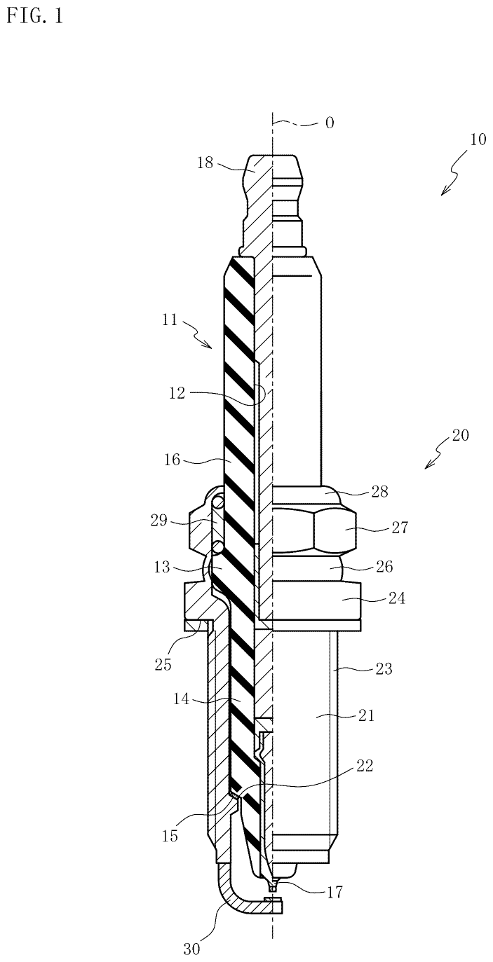

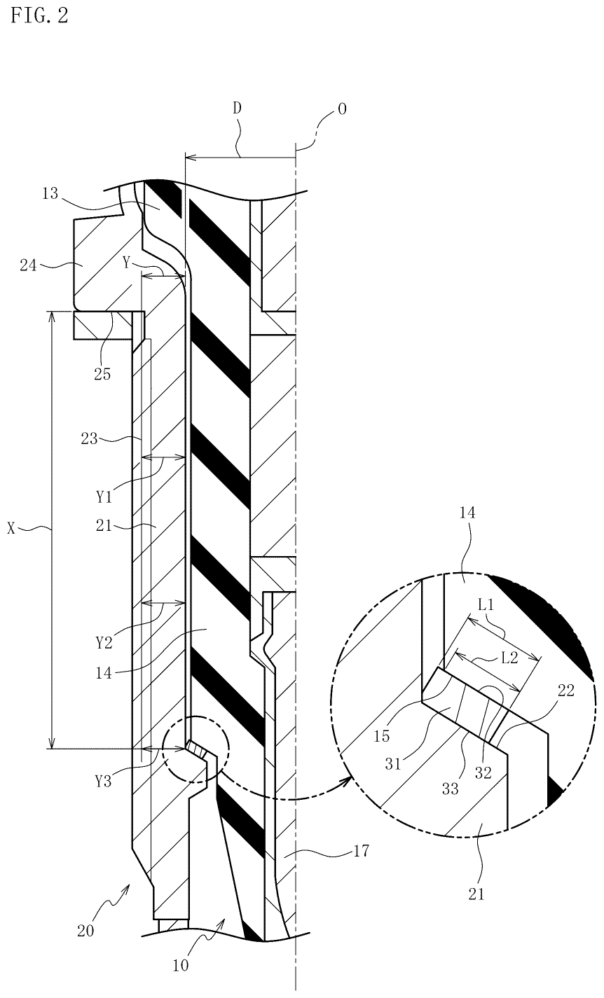

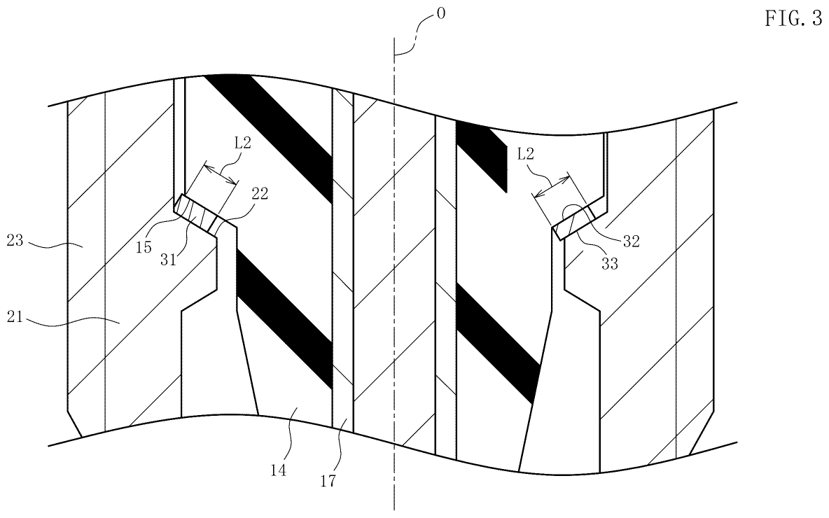

Hereinafter, a preferred embodiment of the present invention will be described with reference to the accompanying drawings. FIG. 1 is a half-sectional view of a spark plug 10 according to one embodiment, with an axial line O as a boundary. In FIG. 1, the lower side in the drawing sheet is referred to as a front side of the spark plug 10, and the upper side in the drawing sheet is referred to as a rear side of the spark plug 10 (the same applies to FIG. 2 and FIG. 3). As shown in FIG. 1, the spark plug 10 includes an insulator 11 and a metal shell 20.

The insulator 11 is a substantially cylindrical member made of a material such as alumina which is excellent in mechanical property and in insulation property under high temperature. The insulator 11 has an axial hole 12 extending along the axial line O. The insulator 11 has a protrusion portion 13 protruding radially outward at the center in an axial-line direction, and a first portion 14 adjacent to the front side of the protrusion portion 13 and a second portion 16 adjacent to the rear side of the protrusion portion 13. The protrusion portion 13 is continuous over the entire circumference of the insulator 11.

The first portion 14 has a frontward facing surface 15 formed on an outer circumference thereof. In the present embodiment, the frontward facing surface 15 is a conical surface continuous over the entire circumference of the first portion 14. The frontward facing surface 15 may be a surface perpendicular to the axial line O and continuous over the entire circumference of the first portion 14.

A center electrode 17 is provided on the front side of an axial hole 12 of the insulator 11. The center electrode 17 is a bar-shaped electrode held by the insulator 11. The center electrode 17 is formed such that a core material having excellent thermal conductivity is embedded in a base material. The base material is formed from a metal material made of Ni or an alloy containing Ni as a main component. The core material is formed from copper or an alloy containing copper as a main component. The core material may be omitted.

The center electrode 17 is electrically connected to a metal terminal 18 in the axial hole 12 of the insulator 11. The metal terminal 18 is a bar-shaped member to which a high-voltage cable (not shown) is connected, and is formed from a conductive metal material (e.g., low-carbon steel, etc.).

The metal shell 20 is a substantially cylindrical member formed from a conductive metal material (e.g., low-carbon steel, etc.). In the metal shell 20, a trunk portion 21, a flange portion 24, a curved portion 26, a tool engagement portion 27, and a crimping portion 28 are connected in this order from the front side to the rear side.

The trunk portion 21 has a rearward facing surface 22 formed on an inner circumference thereof, and an external thread 23 formed on an outer circumference thereof. The rearward facing surface 22 of the trunk portion 21 is disposed on the front side of the frontward facing surface 15 of the insulator 11. In the present embodiment, the rearward facing surface 22 is a conical surface continuous over the entire circumference of the trunk portion 21. The rearward facing surface 22 may be a surface perpendicular to the axial line O and continuous over the entire circumference of the trunk portion 21. The spark plug 10 is screwed via the external thread 23 into a plug hole of an engine (not shown). The external thread 23 has a nominal diameter of not larger than 14 mm, for example.

The flange portion 24 adjacent to a rear end of the trunk portion 21 includes a seating surface 25. The outer diameter of the flange portion 24 is larger than the outer diameter of the external thread 23. The seating surface 25 is an annular surface facing the front side. When the external thread 23 is screwed into the plug hole, axial tension is generated to the external thread 23 by the seating surface 25. In the present embodiment, the seating surface 25 is a surface perpendicular to the axial line O. The seating surface 25 may be a conical surface having a diameter that decreases toward the front side (so-called taper sheet type), corresponding to the shape of the plug hole.

The curved portion 26 connects the flange portion 24 and the tool engagement portion 27. In the curved portion 26, force in such a direction that the flange portion 24 and the tool engagement portion 27 are separated in the axial-line direction is generated, by elastic force due to the bending deformation. The tool engagement portion 27 is a portion with which a tool such as a wrench is engaged, when the external thread 23 is screwed into the plug hole. The crimping portion 28 is an annular portion which is bent radially inward. The crimping portion 28 is located on the rear side with respect to the protrusion portion 13 of the insulator 11. Between the protrusion portion 13 of the insulator 11 and the crimping portion 28, a seal portion 29 filled with powder of talc or the like is provided over the entire circumference of the second portion 16 of the insulator 11.

A ground electrode 30 is a bar-shaped member made of metal (e.g., a nickel-based alloy) connected to the trunk portion 21 of the metal shell 20. The ground electrode 30 forms a spark gap between the ground electrode 30 and the center electrode 17.

FIG. 2 is an enlarged sectional view, including the axial line O, of a part of the spark plug 10. A packing 31 is interposed between the frontward facing surface 15 of the insulator 11 and the rearward facing surface 22 of the metal shell 20. The packing 31 is an annular plate member. The material of the packing 31 is a metal such as iron or steel softer than the metal material forming the metal shell 20. A rear end surface 32 of the packing 31 is in contact with the frontward facing surface 15 of the insulator 11, and a front end surface 33 of the packing 31 is in contact with the rearward facing surface 22 of the metal shell 20.

The spark plug 10 is manufactured by, for example, a method described below. First, the center electrode 17 is inserted in the axial hole 12 of the insulator 11, and the center electrode 17 is disposed such that the front end thereof is exposed to the outside from the insulator 11. Then, the metal terminal 18 is inserted in the axial hole 12 of the insulator 11, and the metal terminal 18 and the center electrode 17 are electrically connected to each other. Next, the packing 31 is disposed on the rearward facing surface 22 of the metal shell 20, and then the insulator 11 is inserted in the metal shell 20 such that the packing 31 is disposed between the frontward facing surface 15 of the insulator 11 and the rearward facing surface 22 of the metal shell 20.

The seal portion 29 is provided between the second portion 16 of the insulator 11 and the metal shell 20, and then, the crimping portion 28 and the curved portion 26 are formed. Thus, an axial-line-direction compressive load is applied, via the packing 31 and the seal portion 29, on a portion from the frontward facing surface 15 to the protrusion portion 13 of the insulator 11, by a portion from the rearward facing surface 22 to the crimping portion 28 of the metal shell 20. Accordingly, the insulator 11 is held by the metal shell 20. Next, the ground electrode 30 is bent, so that the spark plug 10 is obtained.

In the spark plug 10, where an axial-line direction distance between the rearward facing surface 22 and the seating surface 25 of the metal shell 20 is represented as X (mm) and a thickness obtained by subtracting an inner diameter D, of the trunk portion 21, at the position of the seating surface 25 from a pitch diameter of the external thread 23 is represented as Y (mm), Y≤0.1X+1.48, 17.2≤X≤28.2, and Y≥2.6 are satisfied. The pitch diameter of the external thread 23 is a diameter of a virtual cylinder obtained by connecting points where the width of a thread groove of an external thread 23 is equal to the width of a thread ridge thereof.

When the rearward facing surface 22 of the metal shell 20 is a conical surface and the seating surface 25 is a surface perpendicular to the axial line O, a distance X represents an axial-line-direction distance between the rear end of the rearward facing surface 22 and the seating surface 25 of the metal shell 20. When both the rearward facing surface 22 and the seating surface 25 of the metal shell 20 are conical surfaces, the distance X represents an axial-line-direction distance between the rear end of the rearward facing surface 22 and the front end of the seating surface 25 of the metal shell 20. When the seating surface 25 is a conical surface, the front end of the seating surface 25 and the rear end of the trunk portion 21 are at the same position. When the seating surface 25 is a conical surface, a thickness Y represents a thickness obtained by subtracting the inner diameter D, of the trunk portion 21, at the position of the front end of the seating surface 25 from the pitch diameter of the external thread 23. The thickness Y is an average value of the thicknesses (n=3) at the positions of three parts into which the metal shell 20 is equally divided at the position of the seating surface 25 in a circumferential direction.

When a range of the axial-line-direction distance X between the rearward facing surface 22 and the seating surface 25 of the metal shell 20 is equally divided into three parts in the axial-line direction, and thicknesses, of the metal shell 20, at the positions of the three equal parts are represented as Y1, Y2, Y3 in this order from the side closer to the seating surface 25, each of the thicknesses Y1, Y2, Y3 is preferably not less than 90% and not more than 110% of the thickness Y. This is for enhancing accuracy of an inequality that specifies the spark plug 10. Each of the thicknesses Y1, Y2, Y3 is the average value of the thicknesses (n=3) at the positions of the three equal parts into which the metal shell 20 is equally divided in the circumferential direction, at the positions of the three parts into which the range of the distance X of the metal shell 20 is equally divided in the axial-line direction.

In a part of the spark plug 10, the ratio (%) of a length L2 that the rear end surface 32 and the frontward facing surface 15 are in contact with each other to a length L1 of the rear end surface 32 of the packing 31 on one side of the axial line O is different from that on another side of the axial line O, in a cross section including the axial line O. In FIG. 2, L2/L1 is 90%.

FIG. 3 is an enlarged sectional view, including the axial line O, of a part of the spark plug 10. Since the packing 31 is continuous over the entire circumference with the axial line O as the center, the packing 31 is shown on both sides of the axial line O in the cross section including the axial line O. The packing 31 shown in FIG. 2 is shown on the left side of the axial line O in FIG. 3. In FIG. 3, the position of the first portion 14 is offset to the right side with respect to the trunk portion 21, and the position of the packing 31 is offset to the left side with respect to the rearward facing surface 22. As a result, the entire rear end surface 32 of the packing 31 on the right side of the axial line O is in contact with the frontward facing surface 15. Thus, the ratio of the length L2 to the length L1 of the packing 31 on the right side of the axial line O is 100%.

Since the ratio on the left side of the axial line O is 90%, and the ratio on the right side of the axial line O is 100% in the present embodiment, a difference between the ratios on both sides of the axial line O is 10%. The spark plug 10 has portions having different ratios on both sides of the axial line O, respectively, in a part of the entire circumference with the axial line O as the center. Therefore, as compared to the case where there is no difference between the ratios on both sides of the axial line O (e.g., the ratios are 100% on both sides of axial line O), an area where the frontward facing surface 15 of the insulator 11 is in contact with the packing 31 become smaller, and pressure on the packing 31 disposed between the frontward facing surface 15 and the rearward facing surface 22 is increased. Thus, leakage of combustion gas through a gap between the frontward facing surface 15 and the packing 31 can be reduced.

To obtain the ratios on both sides of the axial line O, first, an X-ray fluoroscopic apparatus is used to specify a portion where displacement of the packing 31 relative to the frontward facing surface 15 of the insulator 11 is the largest over the entire circumference with the axial line O as the center. Then, a nondestructive inspection is performed on the spark plug 10 using the X-ray fluoroscopic apparatus or the spark plug 10 is actually cut, and, in a cross section including the specified portion and the axial line O, a length that the packing 31 and the frontward facing surface 15 are in contact with each other is measured, whereby the ratios on both sides of the axial line O is obtained.

In the spark plug 10, portions having the different ratios on both sides of the axial line O are likely to occur if the insulator 11 is bent, for example. If the insulator 11 is bent, the first portion 14 of the insulator 11 is close to one side of the trunk portion 21 with the axial line O as a boundary, and thus the difference between the ratios on both sides of the axial line O is likely to occur. When bending of the insulator 11 is large, the difference between the ratios on both sides of the axial line O is increased, and an outer circumference of the first portion 14 is likely to be pushed on an inner circumference of the trunk portion 21. When the difference between the ratios on both sides of the axial line O is more than 46%, cracking is likely to occur in the outer circumference of the first portion 14 by force generated when the outer circumference of the first portion 14 is pressed on the inner circumference of the trunk portion 21. When the difference between the ratios on both sides of the axial line O is not more than 46%, cracking, which occurs when the first portion 14 is pressed on the trunk portion 21, can be reduced in the insulator 11 (first portion 14).

The spark plug 10 satisfying 23.9≤X≤28.2 (mm) is preferable. A portion from the frontward facing surface 15 to the protrusion portion 13 of the insulator 11 disposed inside the metal shell 20 is allowed to have an appropriate length, and thus bending of the insulator 11 can be made to have an appropriate magnitude. The difference between the ratios on both sides of the axial line O is likely to occur, and thus pressure on the packing 31 disposed between the frontward facing surface 15 and the rearward facing surface 22 is increased. Thus, leakage of combustion gas through a gap between the frontward facing surface 15 and the packing 31 can be further reduced.

### EXAMPLES

The present invention will be described in more detail with reference to examples, but the present invention is not limited to the examples.

### (Production of Samples)

An examiner produced samples of the spark plug 10 of the embodiment, and performed tests for finding the relationship between the distance X and the thickness Y of the metal shell 20. The examiner prepared 336 metal shells 20 having different conditions: the distance X changing from 16.2 mm to 29.2 mm in increments of 1.0 mm (14 kinds); and the thickness Y changing from 2.0 mm to 4.5 mm in increments of 0.1 mm (24 kinds). The dimensions, other than the distance X and thickness Y, of each metal shell 20 were fixed. Low-carbon steel, which is the material of the metal shell 20, is a material defined in JIS G3507-2:2005, and had a tensile strength of 420-470 N/mm², an elongation of 36% or more, a Rockwell hardness of 70-80 HRB, and a reduction of area of 70% or more. The external thread 23 of each metal shell 20 had a nominal diameter of 12 mm. The examiner prepared the same-sized insulators 11 as many as the number of the samples.

The packing 31 was placed on the rearward facing surface 22 of the metal shell 20, the insulator 11 was inserted in the metal shell 20, and the packing 31 was interposed between the frontward facing surface 15 of the insulator 11 and the rearward facing surface 22 of the metal shell 20. The seal portion 29 was provided between the second portion 16 of the insulator 11 and the metal shell 20, and then, fixed axial-line-direction force was applied via the seal portion 29 on the protrusion portion 13 of the insulator 11 by the crimping portion 28. In this manner, 336 kinds of samples were obtained.

### (Test 1)

After the metal shell 20 was removed from the sample, a penetration flaw detection liquid was applied on the first portion 14 of the insulator 11, the excess flaw detection liquid was removed, and then presence/absence of cracking in a surface of the first portion 14 of the insulator 11 was determined through photographic processing. A sample in which no cracking was found in the surface of the first portion 14 was evaluated as A, and a sample in which cracking was found in the surface of the first portion 14 was evaluated as B.

### (Test 2)

In compliance with the screw stripping strength test in JIS B8031:2006, the sample was tightened into a test jig made from iron by a torque wrench until the external thread 23 was stripped, and torque (stripping torque) at that time was measured. A sample having a stripping torque more than 35 Nom was determined as C, and a sample having a stripping torque of 35 N·m or less was determined as D.

### (Test 3)

In Test 3, a test was performed using a sample in which a hole penetrating in a thickness direction of the metal shell 20 was provided in the flange portion 24. The external thread 23 of the sample was inserted in the test jig used in Test 2, and the sample was heated while air pressure of 1.0 MPa was applied to a gap between the metal shell 20 and the insulator 11 from the front side of the metal shell 20. The temperature of the sample and a leakage amount of air through the hole of the flange portion 24 were measured. A sample having temperature of 120° C. or higher when the leakage amount of air reached 10 mL/min. was evaluated as E, and a sample having a temperature lower than 120° C. when the leakage amount of air reached 10 mL/min. was evaluated as F.

### (Test 4)

In Test 4 as well, a test was performed using a sample in which a hole penetrating in the thickness direction of the metal shell 20 was provided in the flange portion 24. The external thread 23 of the sample was inserted in the test jig used in Test 2, and the sample was heated while air pressure of 1.5 MPa was applied to a gap between the metal shell 20 and the insulator 11 from the front side of the metal shell 20. The temperature of the sample and a leakage amount of air through the hole of the flange portion 24 were measured. A sample having a temperature of 200° C. or higher when the leakage amount of air reached 10 mL/min. was evaluated as G, and a sample having a temperature lower than 200° C. when the leakage amount of air reached 10 mL/min. was evaluated as H.

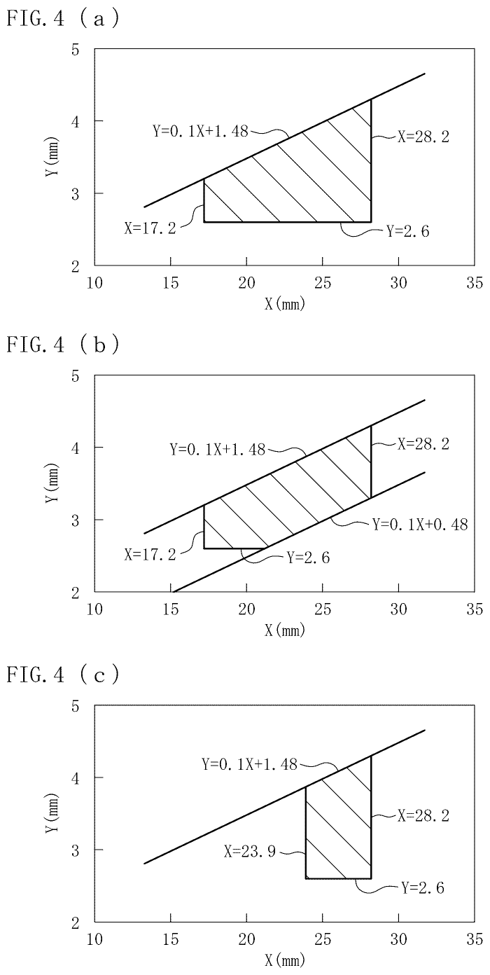

FIG. 4 (a) shows a range in which evaluation of Test 1 was A, evaluation of Test 2 was C, and evaluation of Test 3 was E. When force to be applied on the protrusion portion 13 by the crimping portion 28 is fixed, an axial-line-direction force to be applied on the frontward facing surface 15 of the insulator 11 is changed in magnitude according to the distance X and the thickness Y of the metal shell 20.

The larger the distance X is and the thinner the thickness Y is, the smaller the axial-line-direction force to be applied on the frontward facing surface 15 is. Therefore, it is advantageous for addressing cracking which occurs near the root of the frontward facing surface 15 of the insulator 11, but is disadvantageous for addressing leakage of gas through a gap between the frontward facing surface 15 of the insulator 11 and the rearward facing surface 22 of the metal shell 20. On the other hand, the shorter the distance X is and the thicker the thickness Y is, the larger the axial-line-direction force to be applied on the frontward facing surface 15 is. Therefore, it is advantageous for addressing leakage of gas, but is disadvantageous for addressing cracking which occurs near the root of the frontward facing surface 15 of the insulator 11.

From results of Test 1, it was found that Y=0.1X+1.48 (mm) is a critical point for cracking which occurs near the root of the frontward facing surface 15 of the insulator 11. It was found that occurrence of cracking near the root of the frontward facing surface 15 of the insulator 11 can be reduced in a range of Y≤0.1X+1.48 (mm).

From the results of Test 1, it was found that X=17.2 (mm) is a critical point for cracking which occurs near the root of the frontward facing surface 15 of the insulator 11. It was found that occurrence of cracking near the root of the frontward facing surface 15 of the insulator 11 can be reduced in a range of X≥17.2 (mm).

From the results of Test 1, it was found that Y=4.3 (mm) is a critical point for cracking which occurs in the surface of the first portion 14 of the insulator 11. Since the nominal diameter of the external thread 23 was fixed, it is inferred that, when Y>4.3 mm, the outer circumference of the first portion 14 of the insulator 11 is likely to come into contact with the inner circumference of the trunk portion 21, so that cracking occurs in the outer circumference of the first portion 14. It was found that occurrence of cracking in the surface of the first portion 14 of the insulator 11 can be reduced in a range of Y≤4.3 (mm).

From results of Test 2, it was found that Y=2.6 (mm) is a critical point for stripping of the external thread 23. It was found that the thickness of the trunk portion 21 can be ensured in a range of Y≥2.6 (mm), and thus the stripping torque of the external thread 23 can be ensured to be sufficient.

From results of Test 3, it was found that X=28.2 (mm) is a critical point for leakage of gas through a gap between the frontward facing surface 15 of the insulator 11 and the rearward facing surface 22 of the metal shell 20. It was found that leakage of gas through a gap between the frontward facing surface 15 of the insulator 11 and the rearward facing surface 22 of the metal shell 20 can be reduced in a range of X≤28.2 (mm).

FIG. 4 (b) shows a range in which evaluation of Test 1 was A, evaluation of Test 2 was C, and evaluation of Test 4 was G. From results of Test 4, it was found that Y=0.1X+0.48 (mm) is a critical point for leakage of gas through a gap between the frontward facing surface 15 of the insulator 11 and the rearward facing surface 22 of the metal shell 20. It was found that leakage of gas through a gap between the frontward facing surface 15 of the insulator 11 and the rearward facing surface 22 of the metal shell 20 can be further reduced in a range of Y≥0.1X+0.48 (mm).

FIG. 4 (c) shows, in a range in which evaluation of Test 1 was A, evaluation of Test 2 was C, and evaluation of Test 3 was E, a range in which a difference between the ratios (%) of the length L2 that the rear end surface 32 and the frontward facing surface 15 were in contact with each other to the length L1 of the rear end surface 32 of the packing 31 on both sides of the axial line O in the cross section including the axial line O was likely to occur.

As shown in FIG. 4 (c), in a range in which 23.9≤X≤28.2 (mm) is satisfied, bending of the insulator 11 can be made to have an appropriate magnitude. A difference between the ratios (%) on both sides of the axial line O is likely to occur, and thus, as compared to the case where the ratios (%) on both sides of the axial line O are equal, pressure on the packing 31 disposed between the frontward facing surface 15 and the rearward facing surface 22 is increased. Thus, leakage of gas through a gap between the frontward facing surface 15 and the packing 31 can be further reduced.

While the present invention has been described above with reference to the embodiment, the present invention is not limited to the above embodiment at all. It can be easily understood that various modifications can be devised without departing from the gist of the present invention.

In the above embodiment, the case where the axial-line-direction force is applied via the seal portion 29 on the protrusion portion 13 of the insulator 11 by the crimping portion 28 of the metal shell 20 has been described. However, the present invention is not necessarily limited thereto. Also, in the case where the seal portion 29 is omitted and the axial-line-direction force is applied on the protrusion portion 13 of the insulator 11 by the crimping portion 28 of the metal shell 20, the same effects as in the present embodiment can be provided.

While the spark plug 10 using arc discharge has been described in the embodiment, the present invention is not limited thereto. As a matter of course, the present invention may be applied to another spark plug. Examples of the other spark plug include a spark plug using corona discharge or dielectric barrier discharge.

In the above embodiment, the case where the rearward facing surface 22 of the metal shell 20 is in contact with the frontward facing surface 15 of the insulator 11 via the packing 31 has been described, but the present invention is not limited thereto. As a matter of course, the packing 31 may be omitted and the rearward facing surface 22 of the metal shell 20 may be directly in contact with the frontward facing surface 15 of the insulator 11.

### DESCRIPTION OF REFERENCE NUMERALS

10 spark plug
11 insulator
15 frontward facing surface
20 metal shell
21 trunk portion
22 rearward facing surface
23 external thread
24 flange portion
25 seating surface
28 crimping portion
31 packing (another member)
32 rear end surface of the packing
O axial line

1. A spark plug comprising:
an insulator having a tubular shape extending along an axial-line direction and a frontward facing surface formed on an outer circumference thereof; and
a tubular metal shell provided on the outer circumference side of the insulator, the metal shell including
a tubular trunk portion having a rearward facing surface which is formed on an inner circumference thereof and is in contact with the frontward facing surface directly or via another member, and an external thread formed on an outer circumference thereof,
a flange portion including a seating surface which is adjacent to a rear end of the trunk portion and protrudes outward with respect to the external thread, and
a crimping portion for pressing the insulator toward the front side, wherein,
when an axial-line-direction distance between the rearward facing surface and the seating surface is represented as X (mm) and a thickness obtained by subtracting an inner diameter of the trunk portion at a position of the seating surface from a pitch diameter of the external thread is represented as Y (mm),
Y≤0.1X+1.48, 17.2≤X≤28.2, and Y≥2.6 are satisfied.

2. The spark plug according to claim 1, wherein Y≥0.1X+0.48 is further satisfied.

3. The spark plug according to claim 1, wherein
the other member interposed between the frontward facing surface and the rearward facing surface is an annular packing having a rear end surface in contact with the frontward facing surface,
in a part of the entire circumference with the axial line as the center, the ratio (%) of a length that the rear end surface and the frontward facing surface are in contact with each other to a length of the rear end surface on one side of the axial line is different from that on another side of the axial line, in a cross section including the axial line, and
a difference between the ratios on both sides of the axial line is not more than 46%.

4. The spark plug according to claim 3, wherein 23.9≤ X≤28.2 is further satisfied.

5. The spark plug according to claim 1, wherein the external thread has a nominal diameter of 12 mm.
